(19) United States
(12) Patent Application Publication
(10) Pub. No.: US 2026/0270529 A1
(43) Pub. Date: Sep. 10, 2026

(54) VIDEO PROCESSING METHOD AND APPARATUS, AND DEVICE, MEDIUM AND PROGRAM PRODUCT

(71) Applicant: Beijing Zitiao Network Technology Co., Ltd., Beijing (CN)

(72) Inventors: Rui ZHANG, Beijing (CN); Lixue GONG, Beijing (CN); Lushuang CHEN, Beijing (CN); Youguo GUAN, Beijing (CN)

(21) Appl. No.: 19/491,272

(22) PCT Filed: Jun. 14, 2024
(86) PCT No.: PCT/CN2024/099198

§ 371 Date: Dec. 8, 2025

(30) Foreign Application Priority Data
Jun. 15, 2023 (CN) 202310715849.6

(51) Int. Cl. H04N 21/81; H04N 21/43; H04N 21/439; H04N 21/44; H04N 21/472

(52) U.S. Cl. CPC H04N 21/8113; H04N 21/43072; H04N 21/4394; H04N 21/44008; H04N 21/47217

(57) ABSTRACT

The present disclosure provides a video processing method and apparatus, a device, a storage medium, and a program product. The method includes: determining first video data and audio data; adjusting a playback speed of the first video data based on audio beat features of the audio data to obtain second video data, where visual beat features of an object in the second video data match the audio beat features at corresponding times; and synthesizing the second video data and the audio data into a target video.

### CROSS-REFERENCE TO RELATED APPLICATION(S)

The present application claims priority to Chinese Patent Application No. 202310715849.6, filed on Jun. 15, 2023, and entitled “VIDEO PROCESSING METHOD AND APPARATUS, AND DEVICE, MEDIUM AND PROGRAM PRODUCT”, which is incorporated herein by reference in its entirety.

### FIELD

The present disclosure relates to the field of computer technologies, and in particular, to a video processing method and apparatus, a device, a medium, and a program product.

### BACKGROUND

Users desire that visual effects of published video data match the rhythm of music. Although existing applications can synthesize video data and audio data, the existing applications can only select music from a given music database for synthesis and cannot freely select other music. Moreover, after synthesis, only the visual effects at video scene transitions match the rhythm of the music, which makes it impossible to implement matching of the visual effects of the entire video data with the rhythm of the entire audio data, resulting in poor final presentation effects of the audiovisual data, thus failing to meet the user requirements.

### SUMMARY

The present disclosure proposes a video processing method and apparatus, a device, a storage medium, and a program product to solve the technical problem of inaccurate matching of the visual effects provided to video data with the rhythm of audio data to some extent.

According to a first aspect of the present disclosure, a video processing method is provided. The method includes:
determining first video data and audio data;
adjusting a playback speed of the first video data based on audio beat features of the audio data to obtain second video data, where visual beat features of an object in the second video data match the audio beat features at corresponding times; and
synthesizing the second video data and the audio data into a target video.

According to a second aspect of the present disclosure, a video processing apparatus is provided. The apparatus includes:
a data determination module configured to determine first video data and audio data;
a video processing module configured to adjust a playback speed of the first video data based on audio beat features of the audio data to obtain second video data, where visual beat features of an object in the second video data match the audio beat features at corresponding times; and
a synthesis module configured to synthesize the second video data and the audio data into a target video.

In a third aspect of the present disclosure, an electronic device is provided, and includes: one or more processors and a memory; and one or more programs, where the one or more programs are stored in the memory and executed by the one or more processors, and the program includes instructions used to perform the method according to the first aspect or the second aspect.

According to a fourth aspect of the present disclosure, a non-volatile computer-readable storage medium including a computer program is provided. When the computer program is executed by one or more processors, the processor is enabled to perform the method according to the first aspect or the second aspect.

According to a fifth aspect of the present disclosure, a computer program product is provided, and includes computer program instructions. When the computer program instructions are run on a computer, the computer is enabled to perform the method according to the first aspect.

### BRIEF DESCRIPTION OF THE DRAWINGS

In order to more clearly describe the technical solutions in the present disclosure or in the prior art, the accompanying drawings for describing the embodiments or the prior art are briefly described below. Apparently, the accompanying drawings in the description below show merely the embodiments of the present disclosure, and those of ordinary skill in the art may still derive other accompanying drawings from these accompanying drawings without creative efforts.

FIG. 1 is a schematic diagram of a video processing architecture according to an embodiment of the present disclosure;

FIG. 2 is a schematic structural diagram of hardware of an exemplary electronic device according to an embodiment of the present disclosure;

FIG. 3 is a schematic flowchart of a video processing method according to an embodiment of the present disclosure;

FIG. 4 is a schematic diagram of a principle of time alignment of motion change features and beat features according to an embodiment of the present disclosure;

FIG. 5 shows an example of an audio spectrogram according to an embodiment of the present disclosure;

FIG. 6 shows an example of an audio beat graph according to an embodiment of the present disclosure;

FIG. 7 shows an example of a motion spectrogram according to an embodiment of the present disclosure;

FIG. 8 shows an example of a visual beat graph according to an embodiment of the present disclosure;

FIG. 9 shows an example of alignment of beat features according to an embodiment of the present disclosure;

FIG. 10 shows an example of a video processing method according to an embodiment of the present disclosure; and

FIG. 11 is a schematic diagram of a video processing apparatus according to an embodiment of the present disclosure.

### DETAILED DESCRIPTION OF EMBODIMENTS

In order to make the objects, technical solutions, and advantages of the present disclosure clearer, the present disclosure is further described below in detail with reference to specific embodiments and the accompanying drawings.

It should be noted that unless otherwise defined, the technical or scientific terms used in the embodiments of the present disclosure shall have general meanings as understood by those of ordinary skill in the art to which the present disclosure pertains. “First”, “second”, and like words used in the embodiments of the present disclosure do not indicate any order, quantity, or importance, but are merely used to distinguish between different components. “Include”, “comprise”, or like words mean that an element or item preceding the term encompasses an element or item or its equivalent listed after the term, without excluding other elements or items. “Connection”, “mutual connection”, or like words are not limited to a physical or mechanical connection, but may include an electrical connection, whether direct or indirect. “Up”, “down”, “left”, “right”, and the like are merely used to indicate a relative positional relationship, and the relative positional relationship may change accordingly when an absolute position of the described object changes.

It can be understood that before the use of the technical solutions disclosed in the embodiments of the present disclosure, the user shall be informed of the type, range of use, use scenarios, and the like of personal information involved in the present disclosure in an appropriate manner in accordance with the relevant laws and regulations, and the authorization of the user shall be obtained.

For example, in response to reception of an active request from the user, prompt information is sent to the user to clearly inform the user that a requested operation will require access to and use of the personal information of the user. As such, the user can independently choose, based on the prompt information, whether to provide the personal information to software or hardware, such as an electronic device, an application, a server, or a storage medium, that performs operations in the technical solutions of the present disclosure.

In an alternative but non-limiting implementation, in response to the reception of the active request from the user, the prompt information may be sent to the user in the form of, for example, a pop-up window, in which the prompt information may be presented in text. Furthermore, the pop-up window may further include a selection control for the user to choose whether to “agree” or “disagree” to provide the personal information to the electronic device.

It can be understood that the aforementioned process of notifying and obtaining the authorization of the user is only illustrative and does not constitute a limitation on the implementations of the present disclosure, and other manners that satisfy the relevant laws and regulations may also be applied in the implementations of the present disclosure.

FIG. 1 is a schematic diagram of a video processing architecture according to an embodiment of the present disclosure. Refer to FIG. 1. The video processing architecture 100 may include a server 110, a terminal 120, and a network 130 providing a communication link. The server 110 and the terminal 120 may be connected via a wired or wireless network 130. The server 110 may be a stand-alone physical server, or a server cluster or a distributed system consisting of a plurality of physical servers, or a cloud server that provides basic cloud computing services, such as cloud services, cloud databases, cloud computing, cloud functions, cloud storage, network services, cloud communication, middleware services, security services, and CDN.

The terminal 120 may be implemented in hardware or software. For example, when the terminal 120 is implemented in hardware, the terminal may be various electronic devices having a display screen and supporting page display, including, but not limited to, a smart phone, a tablet computer, an e-book reader, a laptop portable computer, a desktop computer, and the like. When the terminal device 120 is implemented in software, the terminal device may be installed on the electronic devices listed above. The terminal may be implemented as a plurality of pieces of software or software modules (such as a plurality of pieces of software or software modules configured to provide distributed services), or may be implemented as a single piece of software or software module, which are not specifically limited here.

It should be noted that the video processing method provided in embodiments of the present application may be performed by the terminal 120 or by the server 110. It should be understood that the quantity of terminals, networks, and servers in FIG. 1 is only for illustration, and is not intended to be limiting. According to implementation needs, there may be any quantity of terminals, networks, and servers.

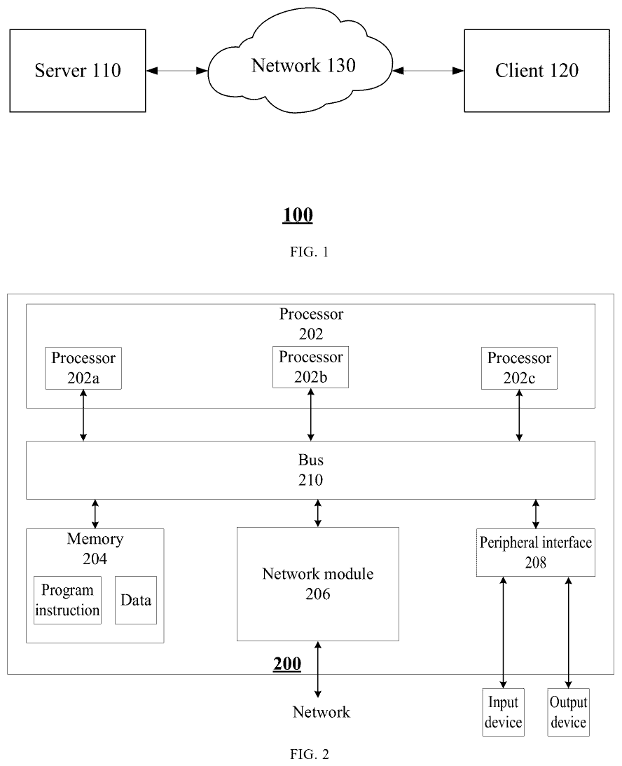

FIG. 2 shows a schematic structural diagram of hardware of an exemplary electronic device 200 according to an embodiment of the present disclosure. As shown in FIG. 2, the electronic device 200 may include: a processor 202, a memory 204, a network module 206, a peripheral interface 208, and a bus 210. The processor 202, the memory 204, the network module 206, and the peripheral interface 208 are communicatively connected to each other within the electronic device 200 through the bus 210.

The processor 202 may be a central processing unit (CPU), a video processor, a neural processing unit (NPU), a microcontroller unit (MCU), a programmable logic device, a digital signal processor (DSP), an application-specific integrated circuit (ASIC), or one or more integrated circuits. The processor 202 may be configured to implement functions related to the technology described in the present disclosure. In some embodiments, the processor 202 may alternatively include a plurality of processors integrated into a single logical component. For example, as shown in FIG. 2, the processor 202 may include a plurality of processors 202a, 202b, and 202c.

The memory 204 may be configured to store data (for example, instructions and computer code). As shown in FIG. 2, the data stored in the memory 204 may include program instructions (for example, program instructions for implementing a video processing method in the embodiments of the present disclosure) and data to be processed (for example, the memory may store configuration files for other modules). The processor 202 may also access the program instructions and the data stored in the memory 204 and execute the program instructions to operate the data to be processed. The memory 204 may include a volatile storage apparatus or a non-volatile storage apparatus. In some embodiments, the memory 204 may include a random-access memory (RAM), a read-only memory (ROM), an optical disk, a magnetic disk, a hard drive, a solid-state drive (SSD), a flash memory, a memory stick, and the like.

The network module 206 may be configured to provide communication between the electronic device 200 and other external devices via a network. The network may be any wired or wireless network capable of transmitting and receiving data. For example, the network may be a wired network, a local wireless network (for example, Bluetooth, Wi-Fi, and near field communication (NFC)), a cellular network, the Internet, or a combination of the above. It should be understood that the type of network is not limited to the aforementioned specific examples. In some embodiments, a network module 306 may include any combination of any quantity of network interface controllers (NICs), radio frequency modules, transceivers, modems, routers, gateways, adapters, cellular network chips, and the like.

The peripheral interface 208 may be configured to connect the electronic device 200 with one or more peripheral apparatuses to implement information input and output. For example, the peripheral apparatus may include an input device such as a keyboard, a mouse, a touchpad, a touchscreen, a microphone, and various sensors, and an output device such as a display, a speaker, a vibrator, and an indicator light.

The bus 210 may be configured to transmit information between various components of the electronic device 200 (for example, the processor 202, the memory 204, the network module 206, and the peripheral interface 208), such as an internal bus (for example, a processor-memory bus) and an external bus (a USB port and a PCI-E bus).

It should be noted that although only the processor 202, the memory 204, the network module 206, the peripheral interface 208, and the bus 210 are shown in the architecture of the electronic device 200, during a specific implementation, the architecture of the electronic device 200 may further include other components necessary for normal operation. In addition, those skilled in the art should understand that the architecture of the electronic device 200 may include only components necessary for implementing the solutions of the embodiments of the present disclosure, and does not necessarily include all the components shown in the figures.

Users desire that visual effects of published audiovisual data match the rhythm of music, which may be referred to as “beat synchronization” of video and audio. However, beat synchronization functions provided by existing applications can only select music from a given music library, and cannot freely add favorite music. In addition, beat synchronization is only used at video transitions, merely cropping the video without rhythm transformations. Alternatively, the video is subjected to a fixed-interval speed change. For example, the video is first accelerated and then decelerated within an interval of 500 ms, maintaining the interval to be approximately unchanged after the speed change, which makes it impossible to implement matching of the visual effects of the entire video data with the rhythm of the entire audio data, resulting in poor final presentation effects of the audiovisual data, thus failing to meet the user requirements. Therefore, how to implement matching of the visual effects of video with the rhythm of audio has become a technical problem that needs to be urgently solved.

In view of this, embodiments of the present disclosure provide a video processing method and apparatus, a device, a storage medium, and a program product. By adjusting the playback speed between video frames of video data, visual beat features of an object in the video data are made to match audio beat features in audio data. This enables the visual rhythm of the finally synthesized video data to match the rhythm of the audio data, thereby improving the presentation effects of audiovisual data and enhancing user experience.

Specifically, since the visual effects of the video data are usually presented through objects displayed by the video data, the video rhythm of the video data can be represented based on visual beat features of objects in an image, such as motion magnitude and direction between video frames. Then, the playback speed of video frames in the video data is adjusted based on the audio beat features of the audio data, such that times at which the visual beat features appear change to be synchronized with times at which the audio beat features appear, thereby completing synchronization between the video rhythm and the audio rhythm and achieving rhythm matching between any video and audio.

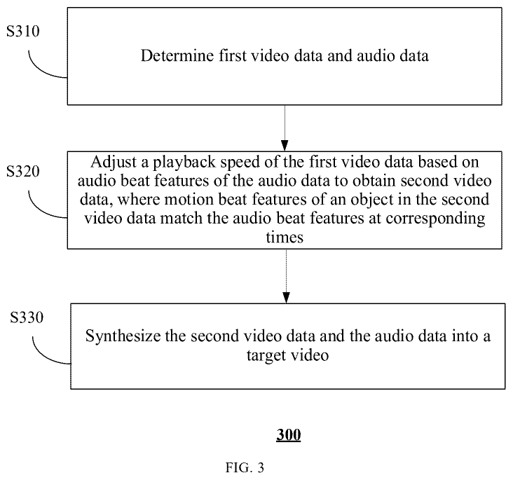

Please refer to FIG. 3. FIG. 3 is a schematic flowchart of a video processing method according to an embodiment of the present disclosure. The video processing method of this embodiment of the present disclosure can be deployed to a client. In FIG. 3, a video processing method 300 may further include the following steps.

In step S310, first video data and audio data are determined.

The first video data and the audio data may come from the same audiovisual data. In some embodiments, a user may select first audiovisual data A and then obtain first video data A1 and audio data A2 based on the first audiovisual data. For example, for the audiovisual data A, the user considers that video rhythm in the audiovisual data A does not match audio rhythm, and the first audiovisual data A may be processed based on the method according to this embodiment of the present disclosure to obtain audiovisual data in which video rhythm matches audio rhythm.

The first video data and the audio data may alternatively come from different audio and video data. In some embodiments, the user may select first audiovisual data B and then obtain first video data B1 based on the first audiovisual data. In addition, the user may select audio data C. For example, for the audiovisual data B, the user expects to replace audio data in the audiovisual data B with the audio data C, but after replacement, video rhythm of the first data time B1 does not match audio rhythm of the audio data C. The first video data B1 and the audio data C may be processed based on the method according to this embodiment of the present disclosure, such that the video rhythm thereof matches the audio rhythm thereof.

In step S320, a playback speed of the first video data is adjusted based on audio beat features of the audio data to obtain second video data. Visual beat features of an object in the second video data match the audio beat features at corresponding times.

The audio beat features may represent rhythm of the audio data. The audio beat features have intensities, where a beat feature with an intensity greater than or equal to an intensity threshold may be a heavy beat, and a beat feature with an intensity less than the intensity threshold may be a light beat. The visual beat features may represent video rhythm of video data. The visual beat features have magnitudes, a larger magnitude indicates a stronger video rhythm, and a smaller magnitude indicates weaker video rhythm.

In some embodiments, a playback speed of the first video data is adjusted based on audio beat features of the audio data to obtain second video data includes:
performing audio beat analysis based on the audio data to obtain the audio beat features;
obtaining visual beat features of an object in the first video data based on optical flow information of the first video data; and
adjusting a playback speed between video frames in the first video data to align the times corresponding to the visual beat features and the audio beat features to obtain the second video data.

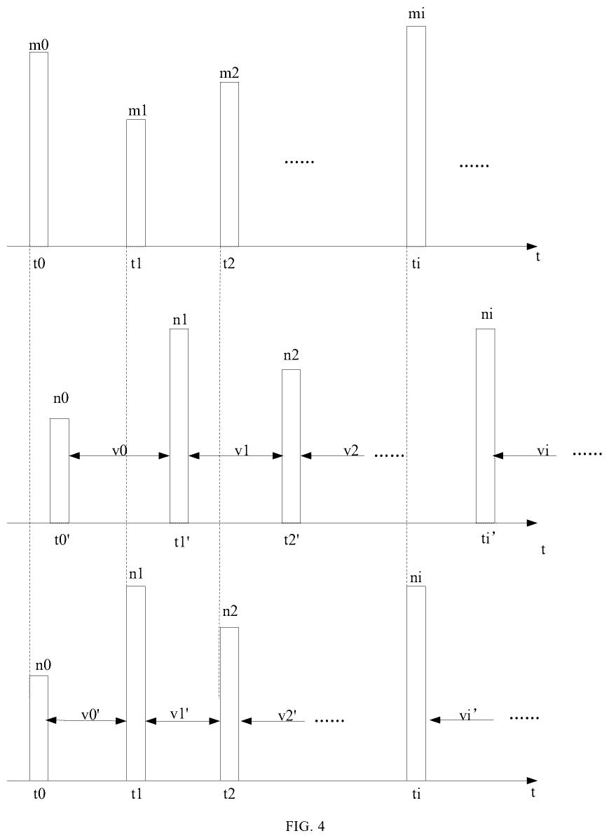

Specifically, please refer to FIG. 4. FIG. 4 is a schematic diagram of a principle of time alignment motion change features, and beat features according to an embodiment of the present disclosure. As shown in FIG. 4, beat analysis (for example, spectrum analysis) may be performed on the audio data to obtain time-related audio beat features of the audio data: an audio beat feature m0 at a time t0, an audio beat feature m1 at a time t1, an audio beat feature m2 at a time t2, . . . , an audio beat feature mi (i is a natural number) at a time ti, . . . . Techniques such as optical flow detection may be used to obtain optical flow information of the object in the first video data to obtain time-related visual beat features of the first video data: a visual beat feature n0 at a time t0′, a visual beat feature n0 at a time t1′, a visual beat feature n2 at a time t2′, . . . , a visual beat feature ni at a time ti′, . . . . The visual beat features n0, n1, n2, . . . , ni, . . . may respectively correspond to video frames Fn0, Fn1, Fn2, . . . , Fni, . . . . A playback speed between video frames Fn0 and Fn1 is v0, a playback speed between video frames Fn1 and Fn2 is v1, . . . , a playback speed between video frames Fni and Fni+1 is vi, . . . . It can be seen that the visual beat features m0 to mi are not synchronized with the visual beat features n0 to ni, and the playback speed between the video frames may be changed to change time points t0′ to ti′ at which motion change features n0 to ni appear, such that time points at which the visual beat features n0 to ni appear align with times points at which the audio beat features m0 to mi appear, and the aligned visual beat features n0 to ni respectively correspond to the time points t0 to ti. Correspondingly, playback speeds between the video frames Fn0 to Fni corresponding to the aligned visual beat features n0 to ni also change as follows. A playback speed between video frames Fn0 and Fn1 is v0′, a playback speed between video frames Fn1 and Fn2 is v1′, . . . , a playback speed between video frames Fni and Fni+1 is vi′, . . . , that is, a playback speed curve v0-vi is changed to a playback speed curve v0′-vi′.

In some embodiments, the performing audio beat analysis based on the audio data to obtain the audio beat features of the audio data includes:
performing frequency analysis on the audio data to obtain time-related spectral features of the audio data, where the spectral features include audio frequencies and corresponding sound intensities;
performing audio beat recognition based on the spectral features to obtain time-related audio beat intensity features; and
performing moving average-based peak detection on the audio beat intensity features to determine the audio beat intensity features corresponding to peaks as the audio beat features.

Specifically, frequency analysis may include Fourier transform, such as a short-time Fourier transform, and time-domain audio data is converted into a frequency-domain audio spectrogram. The audio spectrogram may be an image in which a frequency of audio changes over time, and may describe distribution of sound at each frequency at a moment. Please refer to FIG. 5. FIG. 5 shows an example of the audio spectrogram according to an embodiment of the present disclosure. In FIG. 5, a horizontal coordinate of the audio spectrogram may indicate a time (measured in seconds), and a vertical coordinate may indicate a frequency (measured in HZ). For a frequency at a time t (for example, a frequency in 0 to 8000 HZ), different colors may be used to represent different sound intensities (measured in dB).

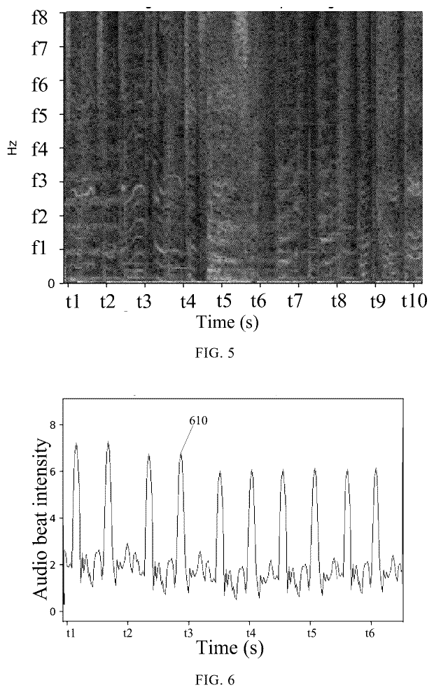

A trained audio beat recognition network may be used to perform audio beat recognition on the spectral features. The audio beat recognition network may be obtained by training a neural network based on training data. The training data may include an audio spectrum training map and a corresponding audio beat training map. The audio spectrum training map is used as input-layer data, and the corresponding audio beat training map is used as output-layer data to train the neural network to obtain the trained audio beat recognition network. Specifically, audio beat recognition may be performed on the spectral features in the audio spectrogram based on the audio beat recognition network to obtain an audio beat graph including the time-related audio beat intensity features. As shown in FIG. 6, FIG. 6 shows an example of the audio beat graph according to an embodiment of the present disclosure. In FIG. 6, a horizontal coordinate of the audio beat graph may indicate a time (measured in seconds), and a vertical coordinate may indicate an audio beat intensity. A higher audio beat intensity at a moment indicates a higher possibility that the moment is an audio beat point.

Then, moving average-based peak detection may be performed on the audio beat intensity features to determine the audio beat intensity features corresponding to the obtained peaks as the audio beat features, for example, an audio beat feature 610 in FIG. 6. The audio beat point is usually a point where a frequency and/or volume changes abruptly. Accordingly, a final audio beat feature point may be determined based on moving average-based peak detection. Specifically, for each moment, a specific quantity of audio beat intensities before the moment (for example, several time windows before a current moment) and/or a specific quantity of audio beat intensities after the moment (for example, several time windows after the current moment) are selected to calculate an average value, so as to obtain an audio beat moving average. An average value corresponding to the audio beat moving average is used as a threshold. Whether an audio beat intensity at each moment is greater than a threshold corresponding to the moment is determined, and if the audio beat intensity is greater than the threshold corresponding to the moment, the moment is an audio beat point, and a corresponding audio beat intensity feature is the audio beat feature.

In some embodiments, the obtaining visual beat features of an object in the first video data based on optical flow information of the first video data includes:
performing optical flow detection on the first video data to obtain optical flow information of pixels in the first video data;
obtaining time-related optical flow distribution features of the first video data based on the optical flow information, where the optical flow distribution features include a plurality of optical flow directions and a corresponding optical flow intensity in each of the optical flow directions; and
performing visual beat analysis based on motion distribution features to obtain the visual beat features of the object in the first video data.

Specifically, significant discontinuous changes of a moving object in video data can be regarded as local significant peaks in a video and is determined as visual beat features. Accordingly, optical flow information that can reflect visual features such as motion magnitude and direction between video frames can be used to perform visual beat analysis. Larger optical flow information indicates a larger magnitude of the visual beat feature and stronger corresponding video rhythm. Accordingly, visual beat recognition processing may be performed on the video data based on the optical flow information to obtain a motion spectrogram and a visual beat graph similar to the audio spectrogram and the audio beat graph of the audio data in FIG. 5 and FIG. 6. As shown in FIG. 7 and FIG. 8. FIG. 7 shows an example of an optical flow spectrogram according to an embodiment of the present disclosure, and FIG. 8 shows an example of the visual beat graph according to an embodiment of the present disclosure.

In some embodiments, the obtaining time-related optical flow distribution features of the first video data based on the optical flow information includes:
obtaining a pixel motion direction of each of the pixels based on angles of the optical flow information, and obtaining a pixel motion magnitude of the pixel based on magnitudes of the optical flow information; and
calculating, for each of the optical flow directions, a sum of the pixel motion magnitudes corresponding to the pixel motion directions having angular differences from the optical flow direction within a preset range to obtain an optical flow intensity corresponding to the optical flow direction.

As shown in FIG. 7, a horizontal coordinate of the optical flow spectrogram may indicate a time (measured in seconds), and a vertical coordinate may indicate an optical flow direction. The optical flow direction may be preset. For an optical flow direction at a moment, different colors may be used to represent different optical flow intensities. Specifically, for optical flow information Ft of each pixel (x, y) in the video data at a moment t, a pixel motion direction of the optical flow information Ft may be represented as an angle φ of the optical flow information Ft, and a pixel motion magnitude may be represented as a magnitude |Ft(x, y)| of the optical flow information Ft. Pixel motion directions and pixel motion magnitudes of all pixels are calculated, and motion magnitudes having angular differences from a same optical direction within a preset range are summed to obtain optical flow magnitude distribution in each optical flow direction. That is, a point D(t, θ) in the optical flow spectrogram in FIG. 7 may be represented as:

$$𝒟 ( t , θ ) = {\sum }_{x , y} \vert {F}_{t} ( x , y ) \vert {\text{?}}_{θ} ( ∠ {F}_{t} ( x , y ) ) , \\ where {\text{?}}_{θ} ( ϕ ) := \{ \begin{matrix}1 & if \vert θ - ϕ \vert \leq \frac{2 π}{{N}_{bins}} \\ 0 & otherwise\end{matrix} ,$$

θ is the optical flow direction, φ is the pixel motion direction, and N_{bins} represents a quantity of optical flow directions. As shown on the vertical coordinate in FIG. 7, the optical flow spectrogram in FIG. 7 includes six preset optical flow directions. By calculating a sum of pixel motion magnitudes of all optical flow information near the optical flow direction θ (for example, different from the optical flow direction θ by a preset angle 2π/N_{bins}), an optical flow intensity in the optical flow direction θ can be obtained.

In some embodiments, performing visual beat analysis based on the optical flow distribution features to obtain the visual beat features includes:
performing visual beat recognition based on the optical flow distribution features to obtain time-related visual beat intensity features; and
performing moving average-based peak detection on the visual beat intensity features to determine visual beat intensity features corresponding to peaks as the visual beat features.

Specifically, similar to an audio beat recognition process, a trained visual beat recognition network may be used to perform visual beat recognition on the optical flow distribution features. The visual beat recognition network may be obtained by training a neural network based on visual beat training data. The visual beat training data may include an optical flow spectrum training map used as input-layer training data and a corresponding visual beat training map used as output-layer training data. The neural network is trained based on the visual beat training data to obtain the trained visual beat recognition network. Specifically, visual beat recognition may be performed on the optical flow distribution features in the optical flow spectrogram based on the visual beat recognition network to obtain the visual beat graph including the time-related visual beat intensity features, as shown in FIG. 8. In FIG. 8, a horizontal coordinate of the visual beat graph may indicate a time (in measured in seconds), and a vertical coordinate may indicate a visual beat intensity. A higher visual beat intensity at a moment indicates a higher possibility that the moment is a visual beat point.

Then, moving average-based peak detection may be performed on the visual beat intensity features to determine the visual beat intensity features corresponding to the obtained peaks as the visual beat features, for example, a visual beat feature 810 in FIG. 8. Specifically, for each moment, a specific quantity of visual beat intensities before the moment (for example, several time windows before a current moment) and/or a specific quantity of visual beat intensities after the moment (for example, several time windows after the current moment) are selected to calculate an average value, so as to obtain a visual beat moving average. An average value corresponding to the visual beat moving average is used as a threshold. Whether a visual beat intensity at each moment is greater than a threshold corresponding to the moment is determined, and if the visual beat intensity is greater than the threshold corresponding to the moment, the moment is the visual beat point, and a corresponding visual beat intensity feature is the visual beat feature.

In some embodiments, the adjusting a playback speed between video frames in the first video data to align the times corresponding to the visual beat features and the audio beat features includes:
filtering the visual beat features and the audio beat features to obtain filtered visual beat features and filtered audio beat features; and
adjusting the playback speed of the video frames in the first video data, such that the filtered visual beat features and the filtered audio beat features are sequentially aligned.

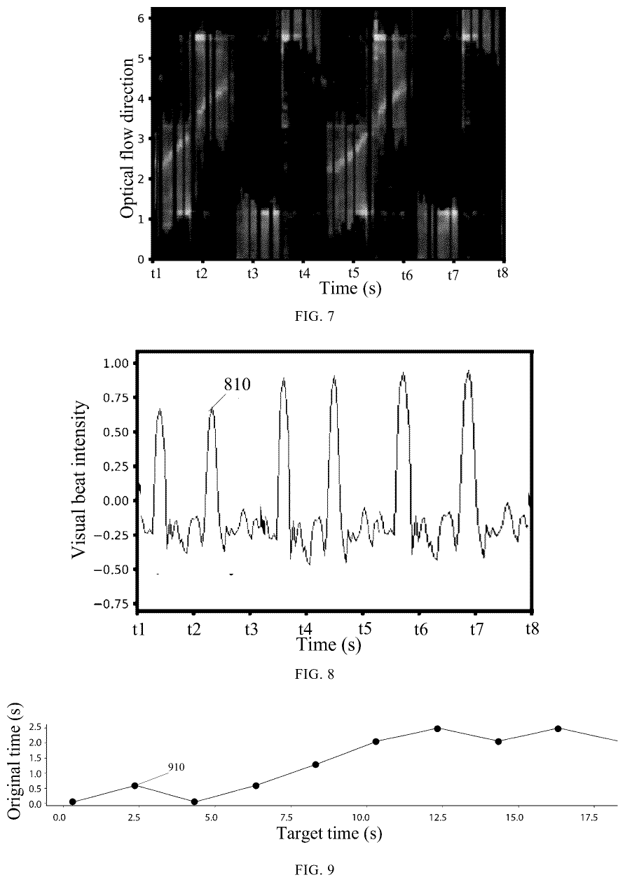

The visual beat features and the audio beat features may be filtered, for example, a point where a beat interval time is too short is removed, such that quantities of the two types of beat features are consistent. For example, please refer to FIG. 9. FIG. 9 shows an example of alignment of beat features according to an embodiment of the present disclosure. In FIG. 9, an i^{th} visual beat feature needs to be speed-adjusted to a moment corresponding to an i^{th} audio beat feature. Therefore, a video speed change curve may be calculated, with a vertical coordinate representing an original time and a longitudinal coordinate representing a target time t0 which the visual beat feature needs to be speed-adjusted. For example, a second visual beat feature 910 is at 0.6 s of an original video, and a second audio beat feature is at 2.4 s of audio. Therefore, a playback speed of the visual beat feature needs to be adjusted, that is, slowed down, such that a time of the visual beat feature 910 reaches 2.4 s.

In some embodiments, before performing optical flow detection on the first video data, the method further includes:
repeating at least part of the first video data, such that an object in the repeated first video data has periodic optical flow changes.

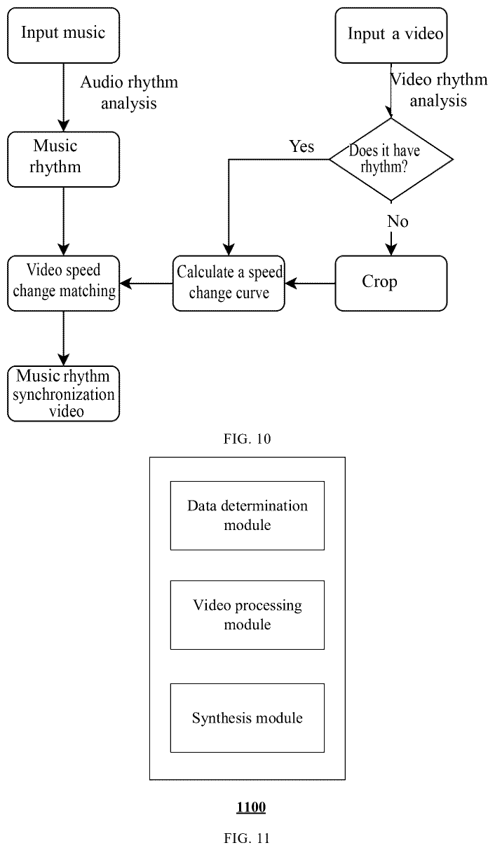

Specifically, the first video data may or may not have fixed video rhythm. When the first video data has the fixed video rhythm, a playback speed of a video frame may be directly changed to match audio rhythm. When the first video data does not have the fixed video rhythm, the first video data may be cropped to have the fixed video rhythm. For example, the part of first video data is removed, or the part of data is repeated multiple times. Please refer to FIG. 10. FIG. 10 shows an example of the video processing method according to an embodiment of the present disclosure. As shown in FIG. 10, music data and first video data may be determined based on a user operation, rhythm analysis is performed on the music data to obtain music rhythm, and video rhythm analysis is performed on the first video data. When it is determined, based on video rhythm analysis, that the first video data has fixed rhythm, a first playback speed curve of the first video data is calculated. When it is determined, based on the video rhythm analysis, that the video data does not have fixed rhythm, the first video data may be cropped, and then a first playback speed curve of the cropped first video data may be calculated. A playback speed between video frames in the first video data may be changed, such that time points at which motion change features appear are aligned with time points at which beat features appear, and the playback speed between the video frames is changed from the first playback speed curve to a second playback speed curve to obtain second video data having the second playback speed curve. Finally, the music data and the second video data are synthesized to obtain a music beat synchronization video in which the video rhythm matches the music rhythm.

In some embodiments, before adjusting a playback speed between video frames in the first video data, the method further includes: setting times and/or intensities of audio beat features based on the user operation or visual beat features.

Specifically, the user may perform operations, such as adding, removing, and moving beat features, to change positions of the audio beat features on a time axis, that is, change times at which the audio beat features appear. Intensities of the audio beat features may also be changed, for example, the intensities of the audio beat features may be increased or decreased. In this way, the user can freely edit times and intensities of matching between the video rhythm and the audio rhythm in the final audio and video, that is, implement free setting of beat synchronization effects.

In step S330, the second video data and audio data are synthesized into a target video.

In some embodiments, the method 300 may further include: using a special effect to play a video frame, in the target video, corresponding to a beat feature that is a heavy beat. For the heavy beat, an intensity of the beat feature is greater than or equal to a preset intensity.

Specifically, the video frame corresponding to the heavy beat may be played with visual effects such as slow playback, magnification, shaking, and the like, to cooperate with matching audio rhythm, to further increase visual impact and improve presentation effects of the target video.

It should be noted that the method in the embodiments of the present disclosure may be performed by a single device, such as a computer or a server. The method in the embodiments may also be applied to a distributed scenario to be completed through cooperation of a plurality of devices. In the distributed scenario, one of the plurality of devices may perform only one or more steps of the method in the embodiments of the present disclosure. The plurality of devices interact with each other to complete the method.

It should be noted that some embodiments of the present disclosure are described above. Other embodiments are within the scope of the appended claims. In some cases, the actions or steps recited in the claims can be performed in an order different from that in the aforementioned embodiments, and can still implement desired results. In addition, the processes depicted in the accompanying drawings are not necessarily required to be shown in a particular or sequential order, to implement desired results. In some implementations, multi-task processing and parallel processing are also possible or may be advantageous.

Based on the same technical concept, corresponding to the method in any one of the aforementioned embodiments, the present disclosure further provides a video processing apparatus. With reference to FIG. 11, the video processing apparatus includes:
a data determination module configured to determine first video data and audio data;
a video processing module configured to adjust a playback speed of the first video data based on audio beat features of the audio data to obtain second video data, where visual beat features of an object in the second video data match the audio beat features at corresponding times; and
a synthesis module configured to synthesize the second video data and the audio data into a target video.

For ease of description, when the aforementioned apparatus is described, the aforementioned apparatus is divided into various modules based on functions for separate description. Certainly, functions of the modules may be implemented in one or more pieces of software and/or hardware when the present disclosure is implemented.

The apparatus in the aforementioned embodiment is configured to implement the corresponding video processing method in any one of the aforementioned embodiments, and has the beneficial effects of the corresponding method embodiment, which are not repeated herein.

Based on the same technical concept, corresponding to the method according to any one of the aforementioned embodiments, the present disclosure further provides a non-transitory computer-readable storage medium storing computer instructions. The computer instructions are used to enable the computer to perform the video processing method according to any one of the aforementioned embodiments.

The computer-readable medium in this embodiment includes permanent and non-permanent, removable and non-removable media and may implement information storage by using any method or technology. Information may be computer-readable instructions, data structures, modules of a program, or other data. Examples of the computer storage medium include but are not limited to a phase-change random-access memory (PRAM), a static random-access memory (SRAM), a dynamic random-access memory (DRAM), other types of random-access memories (RAMs), a read-only memory (ROM), an electrically erasable programmable read-only memory (EEPROM), a flash memory or other memory technologies, a compact disc read-only memory (CD-ROM), a digital versatile disc (DVD) or other optical storage, a cassette tape, tape or disk storage or other magnetic storage devices, or any other non-transmission media that may be configured to store information capable of being accessed by a computing device.

The computer instructions stored on the storage medium in the aforementioned embodiment are used to enable the computer to perform the video processing method in any one of the aforementioned embodiments, and have the beneficial effects of the corresponding method embodiment, which are not repeated herein.

It should be understood by those of ordinary skill in the art that the discussion of any one of the aforementioned embodiments is merely an example, and is not intended to imply that the scope of the present disclosure (including the claims) is limited to these examples; and with the concept of the present disclosure, the technical features in the aforementioned embodiments or different embodiments may also be combined, steps may be implemented in any order, and many other changes may be made to different aspects of the embodiments of the present disclosure as described above and are not provided in detail for simplicity.

In addition, to simplify description and discussion and avoid obscuring an understanding of the embodiments of the present disclosure, well-known power/ground connections to an integrated circuit (IC) chip and other components may or may not be shown in the accompanying drawings that are provided. Furthermore, the apparatus may be shown in the form of a block diagram to avoid obscuring an understanding of the embodiments of the present disclosure, and the following fact is also taken into account: details regarding the implementation of the apparatus in the form of block diagram are highly dependent upon a platform on which the embodiments of the present disclosure are to be implemented (that is, such details should be fully understood by those skilled in the art). In the case where the specific details (for example, circuits) are explained to describe the example embodiments of the present disclosure, it will be apparent to those skilled in the art that the embodiments of the present disclosure may be implemented without these specific details or with changes in these specific details. Therefore, these descriptions should be considered illustrative rather than limiting.

Although the present disclosure has been described with reference to the specific embodiments of the present disclosure, many substitutions, modifications, and variations of these embodiments will be apparent to those of ordinary skill in the art from the above description. For example, the discussed embodiments may be used for other memory architectures (for example, a dynamic RAM (DRAM)).

The embodiments of the present disclosure are intended to cover all such substitutions, modifications, and variations that fall within the broad scope of the appended claims. Therefore, any omissions, modifications, equivalent substitutions, improvements, and the like made within the spirit and principle of the embodiments of the present disclosure are intended to be included within the scope of protection of the present disclosure.

1. A video processing method, comprising:
determining first video data and audio data;
adjusting a playback speed of the first video data based on audio beat features of the audio data to obtain second video data, wherein visual beat features of an object in the second video data match the audio beat features at corresponding times; and
synthesizing the second video data and the audio data into a target video.

2. The method according to claim 1, wherein the adjusting a playback speed of the first video data based on audio beat features of the audio data to obtain second video data comprises:
performing audio beat analysis based on the audio data to obtain the audio beat features;
obtaining visual beat features of an object in the first video data based on optical flow information of the first video data; and
adjusting a playback speed between video frames in the first video data to align times corresponding to the visual beat features and the audio beat features to obtain the second video data.

3. The method according to claim 2, wherein the performing audio beat analysis based on the audio data to obtain the audio beat features of the audio data comprises:
performing frequency analysis on the audio data to obtain time-related spectral features of the audio data, wherein the spectral features comprise audio frequencies and corresponding sound intensities;
performing audio beat recognition based on the spectral features to obtain time-related audio beat intensity features; and
performing moving average-based peak detection on the audio beat intensity features to determine the audio beat intensity features corresponding to peaks as the audio beat features.

4. The method according to claim 2, wherein the obtaining visual beat features of an object in the first video data based on optical flow information of the first video data comprises:
performing optical flow detection on the first video data to obtain optical flow information of pixels in the first video data;
obtaining time-related optical flow distribution features of the first video data based on the optical flow information, wherein the optical flow distribution features comprise a plurality of optical flow directions and a corresponding optical flow intensity in each of the optical flow directions; and
performing visual beat analysis based on the optical flow distribution features to obtain the visual beat features of the object in the first video data.

5. The method according to claim 4, wherein the obtaining time-related optical flow distribution features of the first video data based on the optical flow information comprises:
obtaining a pixel motion direction of each of the pixels based on angles of the optical flow information, and obtaining a pixel motion magnitude of the pixel based on magnitudes of the optical flow information; and
calculating, for each of the optical flow directions, a sum of the pixel motion magnitudes corresponding to the pixel motion directions having angular differences from the optical flow direction within a preset range to obtain an optical flow intensity corresponding to the optical flow direction.

6. The method according to claim 4, wherein the performing visual beat analysis based on the optical flow distribution features to obtain the visual beat features comprises:
performing visual beat recognition based on the optical flow distribution features to obtain time-related visual beat intensity features; and
performing moving average-based peak detection on the visual beat intensity features to determine the visual beat intensity features corresponding to peaks as the visual beat features.

7. The method according to claim 2, wherein the adjusting a playback speed between video frames in the first video data to align times corresponding to the visual beat features and the audio beat features comprises:
filtering the visual beat features and the audio beat features to obtain filtered visual beat features and filtered audio beat features; and
adjusting the playback speed of the video frames in the first video data, such that the filtered visual beat features and the filtered audio beat features are sequentially aligned.

8. The method according to claim 2, wherein before performing optical flow detection on the first video data, the method further comprises:
repeating at least part of the first video data, such that an object in the repeated first video data has periodic optical flow changes;
or
before adjusting a playback speed between video frames in the first video data, the method further comprises: setting the times and/or intensities of the audio beat features based on a user operation or the visual beat features.

9. (canceled)

10. An electronic device, comprising a memory, a processor, and instructions stored on the memory and run on the processor causing the device to:
determine first video data and audio data;
adjust a playback speed of the first video data based on audio beat features of the audio data to obtain second video data, wherein visual beat features of an object in the second video data match the audio beat features at corresponding times; and
synthesize the second video data and the audio data into a target video.

11. A non-transitory computer-readable storage medium, wherein the non-transitory computer-readable storage medium stores computer instructions, and the computer instructions are used to enable a computer device to:
determine first video data and audio data;
adjust a playback speed of the first video data based on audio beat features of the audio data to obtain second video data, wherein visual beat features of an object in the second video data match the audio beat features at corresponding times; and
synthesize the second video data and the audio data into a target video.

12. (canceled)

13. The device according to claim 10, wherein the instructions causing the device to adjust a playback speed of the first video data based on audio beat features of the audio data to obtain second video data comprises instructions causing the device to:
perform audio beat analysis based on the audio data to obtain the audio beat features;
obtain visual beat features of an object in the first video data based on optical flow information of the first video data; and
adjust a playback speed between video frames in the first video data to align times corresponding to the visual beat features and the audio beat features to obtain the second video data.

14. The device according to claim 13, wherein the instructions causing the device to perform audio beat analysis based on the audio data to obtain the audio beat features of the audio data comprise instructions causing the device to:
perform frequency analysis on the audio data to obtain time-related spectral features of the audio data, wherein the spectral features comprise audio frequencies and corresponding sound intensities;
perform audio beat recognition based on the spectral features to obtain time-related audio beat intensity features; and
perform moving average-based peak detection on the audio beat intensity features to determine the audio beat intensity features corresponding to peaks as the audio beat features.

15. The device according to claim 13, wherein the instructions causing the device to obtain visual beat features of an object in the first video data based on optical flow information of the first video data comprise instructions causing the device to:
perform optical flow detection on the first video data to obtain optical flow information of pixels in the first video data;
obtain time-related optical flow distribution features of the first video data based on the optical flow information, wherein the optical flow distribution features comprise a plurality of optical flow directions and a corresponding optical flow intensity in each of the optical flow directions; and
perform visual beat analysis based on the optical flow distribution features to obtain the visual beat features of the object in the first video data.

16. The device according to claim 15, wherein the instructions causing the device to obtain time-related optical flow distribution features of the first video data based on the optical flow information comprise instructions causing the device to:
obtain a pixel motion direction of each of the pixels based on angles of the optical flow information, and obtain a pixel motion magnitude of the pixel based on magnitudes of the optical flow information; and
calculate, for each of the optical flow directions, a sum of the pixel motion magnitudes corresponding to the pixel motion directions having angular differences from the optical flow direction within a preset range to obtain an optical flow intensity corresponding to the optical flow direction.

17. The device according to claim 15, wherein the instructions causing the device to perform visual beat analysis based on the optical flow distribution features to obtain the visual beat features comprises instructions causing the device to:
perform visual beat recognition based on the optical flow distribution features to obtain time-related visual beat intensity features; and
perform moving average-based peak detection on the visual beat intensity features to determine the visual beat intensity features corresponding to peaks as the visual beat features.

18. The device according to claim 13, wherein the instructions causing the device to adjust a playback speed between video frames in the first video data to align times corresponding to the visual beat features and the audio beat features comprises instructions causing the device to:
filter the visual beat features and the audio beat features to obtain filtered visual beat features and filtered audio beat features; and
adjust the playback speed of the video frames in the first video data, such that the filtered visual beat features and the filtered audio beat features are sequentially aligned.

19. The device according to claim 18, wherein before performing optical flow detection on the first video data, the method further comprises:
repeating at least part of the first video data, such that an object in the repeated first video data has periodic optical flow changes;
or
before adjusting a playback speed between video frames in the first video data, the method further comprises: setting the times and/or intensities of the audio beat features based on a user operation or the visual beat features.

20. The medium according to claim 11, wherein the instructions causing the device to adjust a playback speed of the first video data based on audio beat features of the audio data to obtain second video data comprises instructions causing the device to:
perform audio beat analysis based on the audio data to obtain the audio beat features;
obtain visual beat features of an object in the first video data based on optical flow information of the first video data; and
adjust a playback speed between video frames in the first video data to align times corresponding to the visual beat features and the audio beat features to obtain the second video data.

21. The medium according to claim 20, wherein the instructions causing the device to perform audio beat analysis based on the audio data to obtain the audio beat features of the audio data comprise instructions causing the device to:
perform frequency analysis on the audio data to obtain time-related spectral features of the audio data, wherein the spectral features comprise audio frequencies and corresponding sound intensities;
perform audio beat recognition based on the spectral features to obtain time-related audio beat intensity features; and
perform moving average-based peak detection on the audio beat intensity features to determine the audio beat intensity features corresponding to peaks as the audio beat features.

22. The medium according to claim 20, wherein the instructions causing the device to obtain visual beat features of an object in the first video data based on optical flow information of the first video data comprise instructions causing the device to:
perform optical flow detection on the first video data to obtain optical flow information of pixels in the first video data;
obtain time-related optical flow distribution features of the first video data based on the optical flow information, wherein the optical flow distribution features comprise a plurality of optical flow directions and a corresponding optical flow intensity in each of the optical flow directions; and
perform visual beat analysis based on the optical flow distribution features to obtain the visual beat features of the object in the first video data.
